(19) United States
(12) Patent Application Publication
(10) Pub. No.: US 2010/0146631 A1
(43) Pub. Date: Jun. 10, 2010

(54) METHOD AND SYSTEM FOR THE SECURE DISTRIBUTION OF DIGITAL DATA

(75) Inventors: Octavian Folea, Le Kremlin-Bicetre (FR); Sébastien Dupuis, Paris (FR)

Correspondence Address: HARNESS, DICKEY & PIERCE, P.L.C., P.O. BOX 8910, RESTON, VA, 20195, US

(73) Assignee: MEDIALIVE, Montrouge (FR)

(21) Appl. No.: 12/522,598

(22) PCT Filed: Jan. 10, 2008
(86) PCT No.: PCT/FR08/00029

§ 371 Date: Jan. 5, 2010

(30) Foreign Application Priority Data
Jan. 11, 2007 (FR) 0752624

(51) Int. Cl. H04L 9/00

(52) U.S. Cl. 726/26

(57) ABSTRACT

The application relates to a method for the secure distribution of digital data transmitted to a client station, said digital data being in a first digital format of a non audiovisual nature, said method implementing a protection device able to protect data in a second digital format and to transmit them to said client station. According to the invention, said second format is of an audiovisual nature and the method includes a step of converting digital data in said first digital format, into said second format.

### CROSS-REFERENCE TO RELATED APPLICATIONS

This application is a National Phase Entry of International Application No. PCT/FR2008/000029, filed on Jan. 10, 2008, which claims priority to French Patent Application No. 07/52624, filed on Jan. 11, 2007, both of which are incorporated by reference herein.

### BACKGROUND AND SUMMARY

The present invention relates to the field of the protection of digital data. The present invention more particularly relates to a method and a system for the secure distribution of data through a telecommunication network or a physical medium such as a memory card or a DVD. In a conventional way, the present invention provides a method making it possible, on the one hand, to protect and distribute, in a secure manner, digital data up to a user station, the digital data being in the form of an initial binary sequence prior to the application of the method, and on the other hand to restore the initial binary sequence at the user station while preventing a non authorised utilisation of, or access to said digital data.

At present, an increased development of audiovisual on demand and pay per view services are currently known, these services being provided by miscellaneous operators such as mobile telephone operators, internet access providers and cable television channel operators as well as all the other providers of audiovisual services. These operators massively create platforms, i.e. operation systems, computer equipment and software applications able to implement those services. The platforms include systems called “DRM” (Digital Rights Management) systems which control the utilisation of digital works in the form of digital contents through telecommunication networks or on audiovisual physical media of the memory card or DVD types, this control being carried out by implementing protection methods or any other technical means able to authorise or prevent the partial or total consulting of the digital work. The implementation of such DRM systems requires the development of technical and logistic means which are hereinafter called “protection device(s)”.

To prevent the non authorised piracy utilisation of digital contents, most DRM systems provide to the user a digital audiovisual stream which is protected, scrambled and generally encrypted by one or several encoding key, so as to obtain an audiovisual stream of encoded digital data. A descrambling or decoding of the stream at the user's is then conditioned by the reception at the user of a certificate or a license which contains a key or several keys for the descrambling, the certificate or the license being generally sent to the user and exchanged for a paying or non paying transaction. The certificate or the license generally contains right elements relative to possible utilisations of the descrambled digital contents.

The technologies which the present DRM systems are placed on are miscellaneous and well known to the person skilled in the art. They are based on specifications which are standardised by standardisation groups such as OMA DRM 2.0, ISMACryp or MPEG-21 or on proprietary software tools like Window Media DRM of the Microsoft, Fairplay DRM by Apple and Helix DRM by RealNetworks. In most cases, the protection of an audiovisual content by a DRM system is conditioned by:

a) the format of a container (file, stream of binary data) wherein said audiovisual content is stored and transmitted or
b) the type of the audiovisual encoder, if said audiovisual content is compressed.
For example, Microsoft DRM can protect only a content compressed by a limited assembly of encoders, among which WMA (Windows Media Audio) or WMV (Windows Media Video). With the same idea in mind, FairPlay DRM can protect only audio content compressed according to the AAC (Advanced Audio codec) standard.

A method for the secure distribution of digital data transmitted to a client station, said digital data being in a first digital format, is known in the state of the art, said method implementing a protection device able to protect data being in a second digital format and to transmit it towards the client station. Such a method is in document WO2004/034705A which teaches a method and a system for the secure distribution of audiovisual digital data. In this document, the protection of the audiovisual content is supplied at two levels. Surround effect operations are applied to the content shown in an analog form. At the second level, encryption operations are applied to the content shown in a digital and compressed form. The passage between both levels includes a system for converting the signal in an analog form into a signal in a digital form. The method disclosed by WO2004/034705A cannot be applied but on audiovisual data, and not on those of another nature than an audiovisual nature. The present invention thus intends to solve this technical problem.

The document US2006/095382A1 teaches a method and a system for the secure distribution of digital data. In this document, the protection of the content is obtained by using a DRM system (Digital Rights Management) which is flexible and which makes it possible to manage several different DRM systems.

The present invention provides a method which is an alternative method provided by US2006/095382A1 by using already deployed DRM systems and not by providing another one. In this method, the first and the second formats are the same. It more particularly deals with conventional protection devices which make the distribution of audiovisual digital data secure. The format of the container and the type of the encoder prevent using a protection device with data the format of which is different from that which the device is dedicated to. Now at present, the device for protecting audiovisual digital data protects only audiovisual digital data.

The aim of the invention is to use audiovisual digital data protection devices in order to protect digital data other than the audiovisual ones. In parallel, audiovisual services provided by the providers have more and more diversified contents: although the digital sequences which are at present the most secure, using protection devices are audiovisual sequences, the data to be protected are more and more diversified. The latter can be text documents or vectorial animated sequences (for example, animations in the SWF format developed by Macromedia), etc. These data having a format which is different from that of the audiovisual sequences will be called hereinafter “arbitrary data”.

Then it is necessary to update the protection device implemented in the DRM systems so as to take into account the different format of the arbitrary data. This entails important costs for the updating of the DRM systems which requires modifying platforms at a server providing the secure distribution of the audiovisual content and at the user station. The aim of the invention is to reduce such updating costs.

Instead of implementing the device protecting the DRM system itself as a function of the format of the arbitrary data, the invention provides a method able to make the arbitrary data understandable by the DRM system which already exists on a platform, without modifying the devices protecting the existing DRM systems. Other methods for protecting the distribution of audiovisual data use complementary data in the protection processes and the restorations of initial audiovisual data.

The invention firstly relates to a method for the secure distribution of digital data, transmitted to a client station, the digital data being in the form of a first digital format of a non audiovisual nature. The method implements a protection device able to protect data in the form of a second digital format and to transmit them to the client's station. According to the invention, the second format is of an audiovisual nature and the method includes a step of converting digital data in the form of a first digital format into a second format.

Converting digital data into a format adapted to the protection device guarantees not to have to modify the protection device. Thus, the invention makes it possible not to modify the already existing and implemented DRM systems and thus composes a less expensive means to protect the arbitrary data in a format which is different from that of audiovisual data currently used by the DRM systems.

According to a first alternative embodiment, the second format is an audio format of an audiovisual nature and the step of conversion includes:

a step of selecting a frequency and a sampling size of said digital data which are identical respectively with a frequency and a size corresponding to said second format of digital data (31),
a step of sampling said digital data as a function of said frequency and said size of sampling selected according to the step of selection,
and a step of creating digital data in a second format with, as definition parameters, the frequency and the sampling size according to the selection step and as contained in the determined samples according to the sampling step.
Then it should be understood that the method according to the invention provides the conversion of digital data in the form of any format of a non audiovisual nature, provided the frequency and appropriate sampling size are selected, so as to obtain data in the format adapted to the protection device.

According to a second embodiment, the step of converting includes a step of encoding compressed digital data from non compressed digital data. Within the frame of an alternative embodiment, the encoding step is an audio encoding step and it is carried out by a device complying with the Windows Media Audio specifications. Within the scope of a particular application of the method, the digital data are in the form of the first format and the data from a second stream of data generated by a device for processing a nominal audiovisual sequence including nominal data, the processing device also generating a first stream modified data different from the nominal data which is transmitted to the client's station, with the data of the second stream including complementary digital information able to restore the nominal audiovisual sequence.

The invention also aims at a process for restoring digital data into a first digital format of a non audiovisual nature, from received digital data at a client's station into restored digital data in the presence of a first original digital format, the digital data received being protected. According to the invention, the restoration method includes the following steps:

restoration of data in the form of said second digital format of an audiovisual nature from the received digital data,
and conversion of the data into restored digital data in the first original format using the converting device.
Within the scope of an alternative embodiment, the step of conversion includes the following steps:
extraction of samples of digital data supplied by the restoring device according to a frequency and a sampling size of said digital data,
and generation of a sequence of digital data in the first original format from each sample extracted according to the step of extraction.

In the scope of an alternative embodiment, the step of conversion includes the step of decoding compressed data so as to determine digital non-compressed data so as to determine the sequence of digital data in the original format thereof. Within the scope of an alternative embodiment, it is provided that the digital data of a non-audiovisual nature are data from a second data stream including complementary digital information which are complementary to that of a first data stream received by a client's station and that the restoration method further includes a step of restoring a nominal audiovisual sequence by combining said first and second streams. Once again, the invention makes it possible to keep the DRM devices implemented using the converting step: the digital data are restored in their original format thanks to the conversion step. Of course, these alternative embodiments are not exclusive and the method includes a combination of each alternative mentioned here-above.

The invention further aims at a system for a secure distribution of digital data to a client's station with the digital data being in the form of a first digital format of a non-audiovisual nature, the system including a protection device able to protect data presented in a second digital format, said system including means of transmitting protected data to said client's station. According to the invention, the second format is of an audiovisual nature and the system includes a device for converting digital data in the form of the first digital format into the second digital format. Within the scope of an alternative embodiment, the protection device complies with the Windows Media DRM specifications. Within the scope of another alternative embodiment, the system includes a license server which conditions the utilisation of the digital data.

According to yet another alternative embodiment, the distribution system includes a system for processing a nominal audiovisual sequence including nominal data able to generate a first stream of modified data different from the nominal data and a second complementary data stream including complementary digital information able to restore said nominal audiovisual sequence as a function of said first modified stream, said data being shown in said first format composing said data of said second stream. Finally, the invention aims at a system for restoring digital data in a first format of a non-audiovisual nature from received digital data, into restored digital data in a first original digital format. The received digital data are protected and the system includes a restoration device able to restore digital data in a second digital format, from received digital data. According to the invention, the second format is of an audiovisual nature and the system includes a step of conversion able to convert the restored data into digital data in said original format. Within the scope of an alternative embodiment, the restoration system includes a processing device able to restore a nominal audiovisual sequence including nominal data from a first stream of modified data different from the nominal data, and a second complementary data stream including complementary digital information able to restore said nominal audiovisual sequence as a function of said first modified flux, such data being in the form of the first format constituting said data of said second stream.

### BRIEF DESCRIPTION OF DRAWINGS

The present invention will be better understood when reading the following description and referring to embodiments illustrated in the appended drawings, wherein:

FIG. 1 diagrammatically shows, as blocks, the main steps of the methods according to the invention for the emission and the reception of data;

FIG. 2 diagrammatically illustrates, as blocks, the main steps of the distribution method according to the invention;

FIG. 3 diagrammatically shows, as blocks, the main steps of the data restoration method; and

FIG. 4 diagrammatically shows, as blocks, the main steps of the distribution method according to the invention, applied to a second data flow such as described in the application WO 2003/065731.

### DETAILED DESCRIPTION

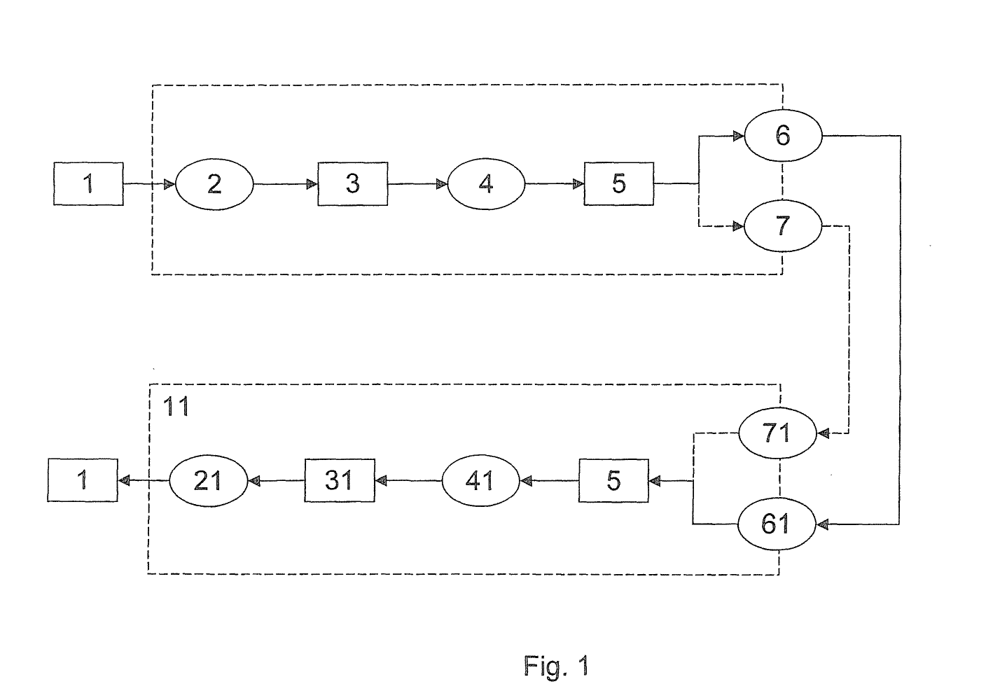

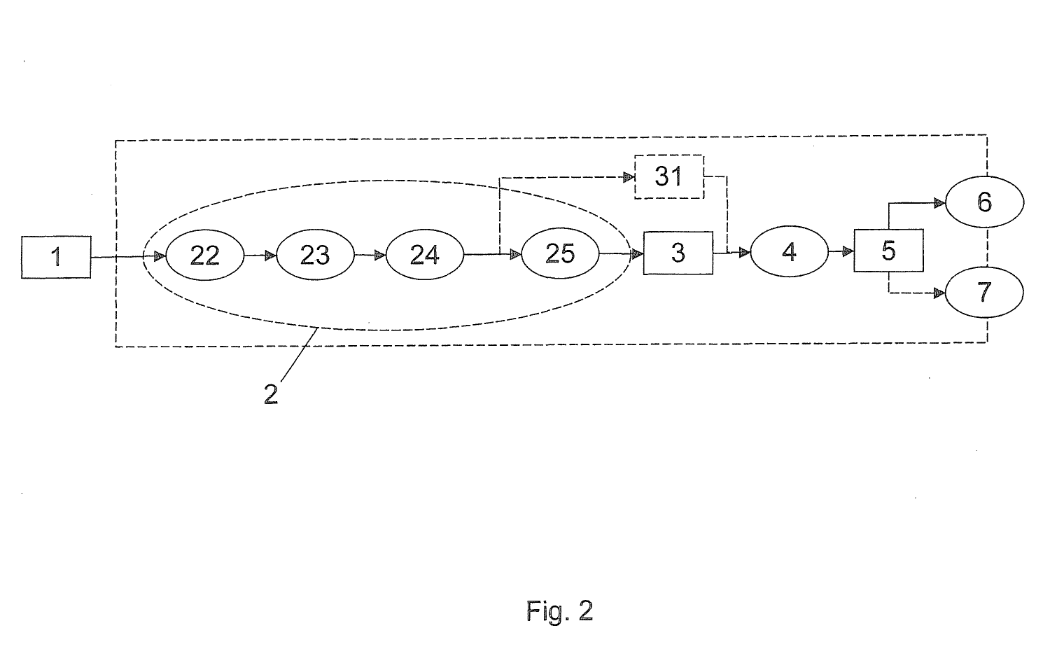

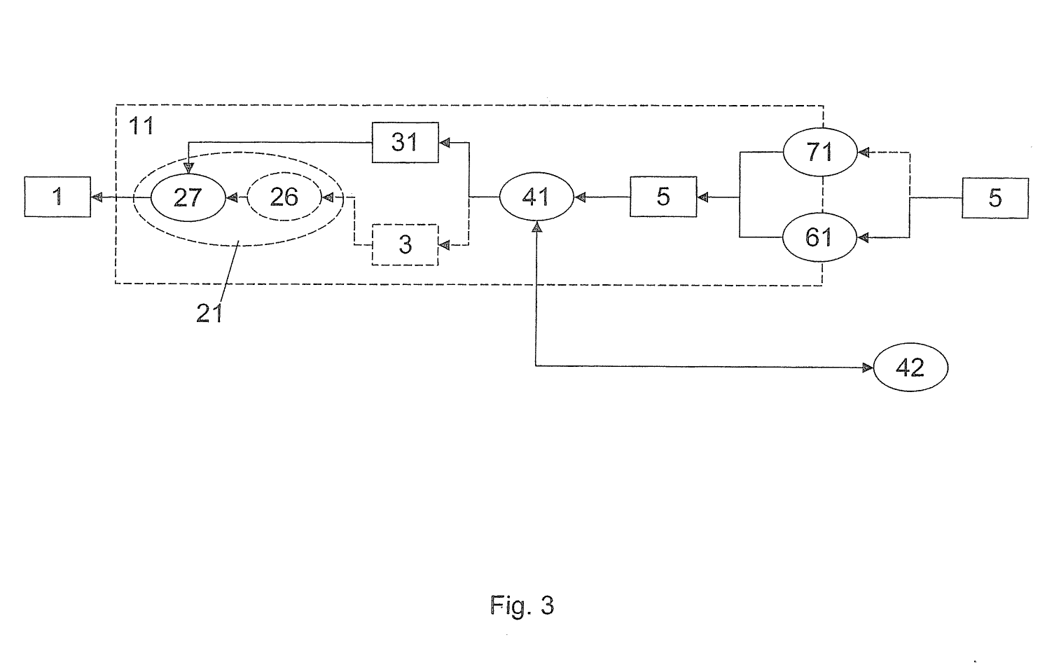

Firstly, reference will more particularly be made to FIG. 2 for describing an embodiment for the distribution method according to the invention. Secondly, an implementation of the data restoration method will be disclosed while referring to FIG. 3. Then FIG. 1 will be referred to for visualising a combination of the data distribution method at the data broadcast system, and the data restoration method at a client's station. And finally, reference will be made to a particular application of the method according to the invention to a nominal audiovisual sequence which is transmitted to the client's station in the form of a first modified stream having a modified content different from the nominal content, and a second complementary stream including complementary digital information capable of restoring said nominal audiovisual sequence as a function of said first modified stream.

Within the scope of one embodiment which shall now be exposed, DRM software is implemented in a protection device 4 according to the specifications of a WM (Windows Media) DRM platform. The Windows Media DRM platform is a platform for the protected distribution of audiovisual contents to users' contents 11 through telecommunication networks 6 or through physical networks 7 such as memory cards and/or DVDs.

The aim is distributing to the station 11 a digital work in the form of digital data 1 in a format which is not adapted to the protection device 4 of the Windows Media DRM platform. In order for the digital data 1 to be protected by the protection device 4 and according to the invention, the digital data 1 are converted into a WMA format adapted to the protection device 4 using a WMA encoder 25 (FIG. 2). WMA (Windows Media Audio) is a proprietary compression format with or without loss of the audio sequences of the PCM type.

The PCM (Pulse Code Modulation) technology is a digital format for expressing non-compressed audio data. Concretely, in order to organise digital data in the PCM format, the method is a follows: a digital implementation of an analog signal is made by sampling, at regular intervals, the height of the signal. Thus, in order to define a PCM format, the following must be known:

the signal sampling frequency, the frequency being the signal sampling rate. For example, a frequency of 44.1 kHz represents 44,100 samples per second (which corresponds to the audio quality of a compact disc);
the size of the sample, corresponding to the size of the digital representation of the signal height for each sample. The measuring unit is the bit. For example, the audio quality of a compact disc requires a format of a sample on 16 bits (or 2 bytes). A still better quality requests a sampling format on 24 bits (or 3 bytes).

The WMA encoder 25 is aimed at converting digital data in the form of a WAVE audio sequence 31 into a WMA encoded sequence. The audio data input in the WMA encoder 25 must be in the WAVE format, a format of the PCM type. The digital data in an audio format must be converted into the WMA format adapted to the protection device. For this purpose, the method is as follows: A conversion device 2 is implemented, which includes a WMA encoder 25, able to convert the digital data 1 into an encoded audiovisual sequence 3. The audiovisual sequence 3 is a compressed audiovisual sequence.

According to an alternative embodiment, the device 2 may generate a non-compressed audio sequence 31 from the digital data 1. According to this alternative embodiment, the conversion device 2 makes it possible to execute the following steps: In a first step 22, conversion parameters are selected: a sampling frequency (the default value is defined at 44,100 Hz) and the sampling size (the default value is fixed at 16 bits). In a second step 23, sequences of digital data 1 at the binary level are cut for sampling purposes according to the selected size, according to a first step. And in a third step 24, non-compressed audio digital data are generated in the WAVE format 31 having as definition parameters the frequencies and the sampling size according to the first step and as a content the samples determined according to the second step. Finally, according to a final step 25, a WMA encoder 25 is implemented for generating the WMA compressed audio sequence 3 from the WAVE format audio digital data 31.

The WMA compressed audio sequence 3 or the non-compressed audio sequence 31 in respective formats which are adapted to the protection device 4 are then protected by the latter, using cryptographic means, so as to generate protected data 5. For this purpose, the DRM WM protection device 4 implements a software tool called WM Rights SDK (Software Development Kit) which has two main functionalities. The first functionality consists in generating the WMA audio sequence 5 protected by encrypting the WMA compressed audio sequence 3 or the non compressed audio sequence 31. The second functionality refers to the transmission of licenses for using the content to the restoring device 41 further to an attempted restoration of the audiovisual digital data.

In another embodiment, the WM DRM protection device 4 implements a software tool called WM SDK format which has two main functionalities. The first functionality is identical to the first functionality presented by WM Rights Manager SDK. The second functionality consists in implementing a restoring device 41 the role of which is to restore audiovisual digital data protected using a WM DRM protection device 4. The protected data 5 are then transmitted through the network 6 to the client's station 11 when connected to the network.

According to an alternative embodiment, the protected data can be recorded on the physical medium 7 according to a step 10 represented by a doted line arrow in FIG. 2. Within the scope of this embodiment, means 71 should then be provided at the client station for retrieving the protected data from the physical medium 7.

Now reference will be made to FIG. 3 for describing a data restoration method at a user station. The protected data 5 are received by the client's station 11 at a port 61 connected to the network 6 or at the means 71 mentioned hereabove which can in particularly be composed of a physical medium player of the compact disc player type or memory card player type. The protected data 5 are then transmitted to a restoring device 41.

The restoration device then checks with a license server 42 that the license allows it to restore the data. This step is represented by the double direction arrow in FIG. 3. If the license authorises the restoration of data, the restoration device 41 restores and decodes data in a way known per se, so as to obtain restored and decoded data 31 in a WAVE digital format.

According to another alternative embodiment, the restoration device 41 restores data in a way known per se, so as to obtain restored data 3. The decoded data 31 are then transmitted to a conversion device 21 which converts it into digital data 1 restored in the original format.

According to another alternative embodiment, the restored data 3 are then transmitted to a conversion device 21 which converts it into digital data 1 restored in the original format. For this purpose, the conversion device 21 implements the step referenced 27 in FIG. 3.

During this last step 27, a sequence of digital data 1 is generated in the original format, this step 27 including:

a step of sampling data 31 which are transmitted through the restoration device 41 according to the sampling frequency and the sampling size of the data 31
a step of generating said digital data sequence 1 by concatenating, at a binary level, each sample obtained according to the sampling step.

According to another alternative embodiment, the conversion device 21 implements an additional step 26 prior to executing the step 27. In the additional step 26, the non compressed data 31 are determined by decoding the compressed digital data 3.

FIG. 1 illustrates the implementation of methods according to the invention upon the transmission and the reception of data. The conversion device 2 converts the arbitrary digital data 1 into an audiovisual sequence 3, the format and possibly the encoding of which are adapted to the protection device 4 implementing a DRM software able to protect and transform the audiovisual sequence 3 into a protected audiovisual sequence 5.

According to another embodiment, the conversion device 2 converts the arbitrary digital data 1 into an audiovisual sequence 31 the format and possibly the encoding of which are adapted to the protection device 4 implementing a DRM software able to protect and transform the audiovisual sequence 31 into a protected audiovisual sequence 5. The protected audiovisual sequence 5 generated by the protection device 4 is transmitted to the client's station 11 by using two alternative transmission channels: a telecommunication network or the conventional broadcast network 6 or a physical medium 7 of the compact disc, DVD, memory card types, or any other physical medium including a memory capable of storing digital data. The client's station 11 retrieves said protected audiovisual sequence 5 by using the physical media player 71 or the telecommunication network interface 61. The restoration device 41 retrieves the audiovisual sequence 31 from the protected audiovisual sequence 5, the restoration device being compatible with the protection device 4.

According to another alternative embodiment, the restoration device 41 retrieves the audiovisual sequence 3 from the protected audiovisual sequence 5, the restoration device being compatible with the protection device 4. The reconversion device 21 applies the reverse operation relative to the conversion device 2 and thus generates initial arbitrary digital data 1.

Reference will now be made to a particular application of the method according to the invention to a nominal audiovisual sequence which is transmitted to the client's station in the form of a first modified stream having a modified content different from the nominal content, and a second additional stream including complementary digital information able to restore said nominal audiovisual sequence as a function of said first modified stream. As mentioned hereabove, such a method is described in the international patent application WO 2003/065731.

This application for a patent more particularly described a method for the secure distribution of an audiovisual sequence from a nominal audiovisual sequence to a receiving equipment, said nominal audiovisual sequence having a nominal content, the method including steps during which:

a first modified stream is generated which has a modified content different from the nominal content,
the second complementary stream is generated which includes complementary digital information able to restore said original audiovisual sequence from the calculation, as a function of said first modified stream;
and said modified stream and said complementary information are transmitted to said receiving equipment so as to allow the restoration, at the receiving equipment, of said original audiovisual sequence.

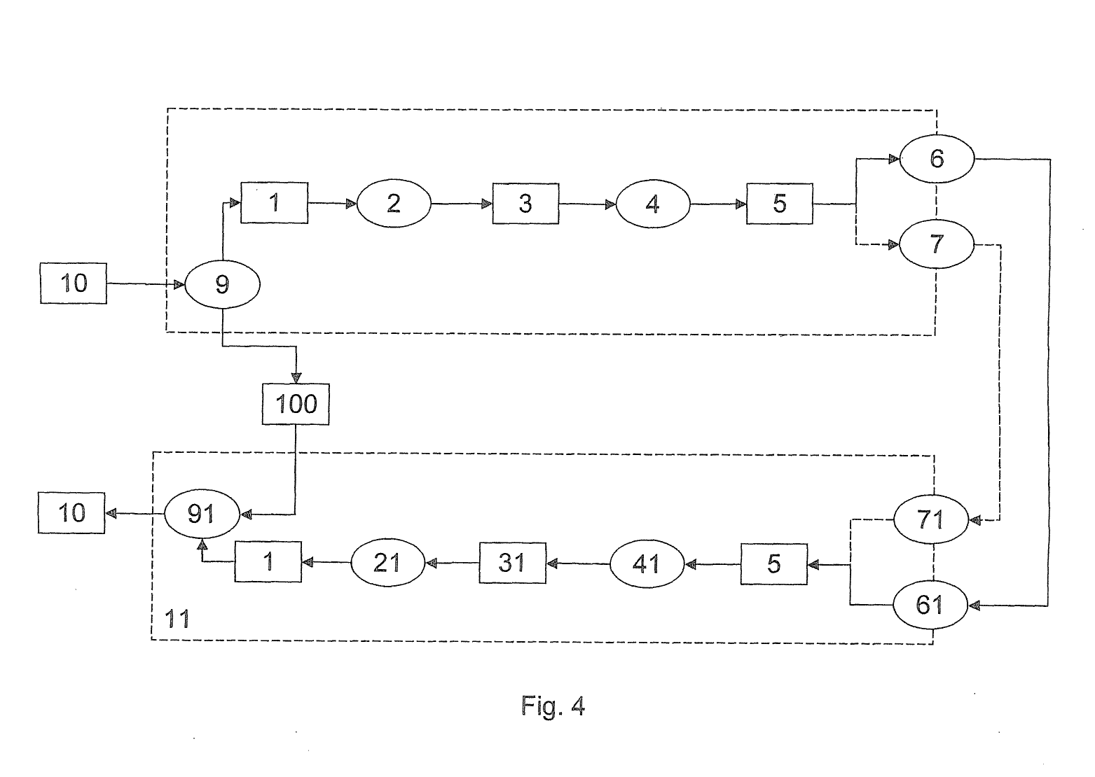

The embodiment shown in FIG. 4 has the advantage of implementing a DRM system with a known protection module for example such as the one described in application WO 2003/065731. Within the scope of the application of the method to the protected audiovisual sequence as per the method described in the document WO-2003/065731, the initial arbitrary digital data 1 are composed of the second complementary stream, which is itself generated by a processing device 9 according to the method described in the application WO 2003/065731. The original audiovisual sequence bears reference 10 in FIG. 4.

Upon generation of the second complementary stream, the processing device 9 generates a first modified nominal stream 100 for distributing it to the client equipment 11 through the network 6 or the physical medium 7 such as previously described. The consumption of the original audiovisual sequence 10 from a first modified nominal stream 100 is conditioned by the restoration of the second complementary stream, thus the initial arbitrary digital 1. The restoration of initial arbitrary digital data 1 is carried out according to the method according to the invention. The original audiovisual sequence 10 is restored by a restoration device 91 from said initial arbitrary digital data 1 and said first modified nominal stream 100, according to the method described in the application WO 2003/065731.

1. A method for the secure distribution of digital data transmitted to a client station, said method comprising to operably protect data in the form of a second digital format of an audiovisual nature, and to transmit these to said client station said first format being of another nature than an audiovisual one, and converting digital data in the form of said first digital data into said second format.

2. A distribution method according to claim 1, wherein said second format is an audio format of an audiovisual nature, and the step of conversion further comprises:
selecting a frequency and a sampling size for said digital data respectively identical to a frequency and a size corresponding to said second format of digital data;
sampling said digital data as a function of said frequency and said sampling size selected; and
creating digital data in said second format having, as definition parameters, the frequency and the sampling size according to the step of selection and as a content, the samples determined according to the step of sampling.

3. A distribution method according to claim 1, wherein said step of conversion further comprises encoding compressed digital data from non-compressed digital data.

4. A distribution method according to claim 3, wherein said encoding step further comprises audio encoding by a device complying with the Windows Media Audio specifications.

5. A distribution method according to claim 1, wherein said digital data in a first format are data of a second data stream generated by a device for the processing of the nominal audiovisual sequence including nominal data, said processing device also generating a first stream of modified data which are different from said nominal data transmitted to said client station, said data of said second stream including complementary digital information able to restore said nominal audiovisual sequence.

6. A method for restoring digital data into a first digital format of another nature than an audiovisual one from digital data received at a client station into restored digital data in a first original digital format, said received digital data being protected, the restoring method comprising:
restoring data in the second digital format of an audiovisual nature, from digital data; and
conversion of said data into restored digital data in said first original format using a conversion device.

7. A restoration method according to claim 6, wherein said step of conversion further comprises:
extraction of samples of digital data supplied by a restoration device according to a frequency and a sampling size of said digital data; and
generation of a digital data sequence in said first original format from each sample extracted as per this step of extraction.

8. A restoration method according to claim 6, wherein said step of conversion further comprises decoding compressed data in order to determine non-compressed digital data.

9. A method for restoration, according to claim 6, wherein said digital data of another nature than an audiovisual nature are data from a second data stream including digital information complementary to those of a first data stream received by said client station, said method further comprising restoring a nominal audiovisual sequence by combining said first and second streams.

10. A system for the secure distribution of digital data to a client station, said digital data being in a first digital format of a nature other than an audiovisual nature, said system comprising a protection device able to protect data in the form of a second digital format, a transmitter operably transmitting protected data to said client station, said second format is of an audiovisual nature, and a conversion device of the digital data in said first digital format, into said second digital format.

11. A distribution system according to claim 10, wherein said protection device is in compliance with the Windows Media DRM specifications.

12. A distribution system according to claim 10, further comprising a license server which conditions the utilisation of said digital data.

13. A distribution system according to claim 10, further comprising a processor operably processing a nominal audiovisual sequence including nominal data, able to generate a first stream of modified data which are different from the nominal data, and a second stream of complementary data including complementary digital information able to restore said nominal audiovisual sequence as a function of said first modified stream, said data being in said first format composing said data of said second stream.

14. A system for restoring digital data in a first format of a nature other than an audiovisual nature from received digital data into restored digital data in a first original digital format said system comprising including a restoration device able to restore digital data in a second digital format from said received digital data, said second format being of an audiovisual nature, and a conversion device able to convert said restored data into digital data in said first original format, said received digital data being protected.

15. A restoration system according to claim 14, further comprising a processing device able to restore a nominal audiovisual sequence including nominal data from a first stream of modified data different from the nominal data, and a second stream of complementary data including complementary digital information able to restore said nominal audiovisual sequence as a function of said first modified stream, said data being in said first format composing said data of said second stream.
